(19) United States
(12) Patent Application Publication
(10) Pub. No.: US 2002/0143957 A1
(43) Pub. Date: Oct. 3, 2002

(54) Relay server, network device, communication system, and communication method

(75) Inventor: Yoshifumi Tanimoto, Uji-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/116,615

(22) Filed: Apr. 2, 2002

(30) Foreign Application Priority Data
Apr. 3, 2001 (JP) 2001-104448
Apr. 3, 2001 (JP) 2001-104545

(51) Int. Cl. G06F 15/16

(52) U.S. Cl. 709/227; 709/205

(57) ABSTRACT

A relay server for realizing broadcasting from a network apparatus of one side to a plurality of network apparatus of the other side via the Internet. A first terminal which carries out the communication, makes login to a relay server, and reserves a connection in advance. When carrying out the broadcasting from the first terminal to second and third terminals, the first terminal transmits connection demand information for the second and third terminals to the relay server. When the second and third terminals approve the connection, the relay server associates a first connection with the first terminal and a second connection with the second terminal, and associates a third connection with the first terminal and a fourth connection with the third terminal. Then, the relay server forwards information transmitted from the first terminal to the second and third terminals, and thereby realizes the broadcasting.

### CROSS REFERENCES TO RELATED APPLICATIONS

This application claims priority under 35 USC 119 of Japanese Patent Application Nos. 2001-104448, and 2001-104545 filed in JPO on Apr. 3, 2001, and Apr. 3, 2001, respectively, the entire disclosures of which are incorporated herein by reference.

### BACKGROUND OF THE INVENTION

1. Field of the Invention

The present invention relates to a communication system wherein a plurality of network devices and a relay server are connected by a network, and to a communication method in such a communication system, and to a relay server and a network device to be used in such a communication system (hereinbelow, a network device is also referred to as a network apparatus).

2. Description of the Related Art

FIG. 11 is a view showing a general system using the Internet. In FIG. 11, the reference numerals 1, 2 designate local systems, 3 the Internet, 11, 12, 21, 22 terminals, 13, 23 gateways, and 14, 24 LANs (Local Area Network). The terminal 11, the terminal 12, the gateway 13, and the like are connected by the LAN 14 to form a local system 1. The gateway 13 is connected to the Internet 3 along with the LAN 14, and the Internet can be used from various network apparatus, such as the terminal 11 or the terminal 12 on the LAN 14. Moreover, a local system 2 is formed in the same manner, and the terminal 21, the terminal 22, the gateway 23 and the like are connected by the LAN 24 to form the local system 2. The gateway 23 is connected to the Internet 3 along with the LAN 24, and the Internet can be used from various network apparatus, such as the terminal 21 or the terminal 22 on the LAN 24. Moreover, other various apparatus can be connected by the LAN 14 within the local system 1, and by the LAN 24 within the local system 2.

According to such a system, generally, one or a plurality of global IP addresses are assigned to the local system 1 and the local system 2, but the global IP address is not assigned to each of the network apparatus within the local system 1 and the local system 2. A private IP address is assigned to each network apparatus within each of the local system 1 and the local system 2, and by using functions such as NAT (Network Address Translation) or IP masquerade by the gateway 13 and the gateway 23, the private IP address is converted into the global IP address. By using the gateway 13 and the gateway 23 having such functions for converting the IP address, for example, in the local system 1, the terminal 11 and the terminal 12 are to use the Internet 3 via the gateway 13. Moreover, in the local system 2, the terminal 21 and the terminal 22 are to use the Internet 3 via the gateway 23.

Moreover, the gateway 13 and the gateway 23, or other network apparatus or the like are provided with functions such as a firewall or a proxy server, and also structure has been used in which respective terminals use the Internet 3 via these devices, and the safety in the system is improved.

For example, when attempting to access the terminal 11 within the local system 1 from the Internet 3, the global IP address of the gateway 13 can be learned, but the private IP address of the terminal 11 cannot be learned. Therefore, under the general connection method, the terminal 11 cannot be accessed from the outside of the local system 1. Moreover, there are cases in which sites which can be accessed are limited by the firewall function or the like of the gateway 13. In addition, likewise, the same access limitation applies to the terminal 12, and also applies to the terminal 21 and the terminal 22 within the local system 2.

Furthermore, the terminal 11 or the terminal 12 within the local system 1, or the terminal 21 or the terminal 22 within the local system 2 is generally provided with only a client function, and is not provided with a function as a server for accepting information from other network apparatus. Therefore, unless accessing to other network apparatus is performed from the terminal 11, the terminal 12, the terminal 21, and the terminal 22, the information cannot be transmitted to these terminals from other network apparatus.

### SUMMARY OF THE INVENTION

An object of the present invention is to provide a communication system and a communication method for realizing broadcasting from a network device within a certain local system to a plurality of network devices including the network device within other local systems via the Internet, and provide a relay server and a network device to be used in such a communication system.

According to one aspect of the present invention, there is provided a relay server including communication means capable of carrying out the communication with a plurality of network devices, and control means for relaying the communication between a network device at one side and a plurality of network devices at the other side which are connected capable of carrying out the communication by the communication means. The relay server is capable of carrying out the communication in both directions between the network device of one side and a plurality of network devices of the other side. By relaying the communication of the two sides, the communication can be realized substantially between the network device of one side and a plurality of network devices of the other side. As a result, it is possible to carry out the broadcasting from the network device of one side to the network devices of the other side and to carry out its reverse communication.

According to another aspect of the present invention, when the communication is being carried out between the network device of one side and a plurality of network devices of the other side, based on a releasing demand from the network device of the one side, it is possible to disconnect the communication between the network device of the other side designated by the releasing demand and the network device of the one side. Alternatively, based on the releasing demand from the network device of the other side, it is possible to disconnect the communication between the network device of the other side which transmitted the releasing demand and the network device of the one side. In this case, it is possible to continue the communication as it is between the network device of the one side and the network devices of the other side which were not designated by the releasing demand from the network device of the one side or/and did not transmit the releasing demand.

According to another aspect of the present invention, based on a demand from the network device of the one side or from the network device of the other side, the communication between the network device of one side and the network device of the other side can be transferred to the communication using a different connection between the network device of the one side and the relay server. The network device of the other side whose communication is transferred to the communication using the different connection can carry out the communication with the network device of the one side, independently of the communication of the other network devices of the other side, by using a connection as it is which has been being used for the connection with the relay server until the communication is transferred. The transferring of the communication can be carried out inversely. In other words, the communication of the network device which has been carrying out the communication with the network device of the one side independently of the other network devices by the relay server using a different connection with the network device of the one side can be transferred to the communication using a connection which is being used for the communication with the other network devices of the other side, and thereby, the broadcasting communication can be continued.

According to another aspect of the present invention, it is possible to carry out communication between the network devices, by establishing a connection between the network device and the relay server, and by the relay server relaying the communication between the network device and another network device or other network devices which have established connections with the relay server. By using this communication manner, it is possible to realize the broadcasting communication by establishing a plurality of connections between the relay server and the network devices such that these plural connections respectively enable the communication with other network devices, and by transmitting the same information through these plural connections.

Additional objects, aspects, benefits and advantages of the present invention will become apparent to those skilled in the art to which the present invention pertains from the subsequent detailed description and the appended claims, taken in conjunction with the accompanying drawings.

### BRIEF DESCRIPTION OF THE DRAWINGS

FIG. 1 is a block diagram showing an example of a communication system including a first embodiment of a relay server of the present invention;

FIGS. 2A and 2B are illustrations showing an example of a procedure in broadcasting according to the example of the communication system shown in FIG. 1;

FIGS. 3A and 3B are illustrations showing another example of the procedure in the broadcasting according to the example of the communication system shown in FIG. 1;

FIGS. 4A and 4B are illustrations showing an example of a procedure at the time of disconnection of the destination of the broadcasting according to the example of the communication system shown in FIG. 1;

FIGS. 5A and 5B are illustrations showing another example of the procedure at the time of disconnection of the destination of the broadcasting according to the example of the communication system shown in FIG. 1;

FIGS. 6A to 6D are illustrations showing an example of a procedure at the time of transferring the communication with the destination of the broadcasting to communication using a different connection according to the example of the communication system shown in FIG. 1;

FIG. 7 is a block diagram showing a second embodiment of a communication system of the present invention;

FIGS. 8A to 8C are illustrations showing an example of the operation at the time of the start of the communication according to the second embodiment of the communication system shown in FIG. 7;

FIGS. 9A and 9B are illustrations showing an example of individual communication in the second embodiment of the communication system shown in FIG. 7;

FIGS. 10A and 10B are illustrations showing an example of the broadcasting in the second embodiment of the communication system shown in FIG. 7; and

FIG. 11 is a view showing an example of a general system using the Internet.

### DETAILED DESCRIPTION OF THE INVENTION

(First Embodiment)

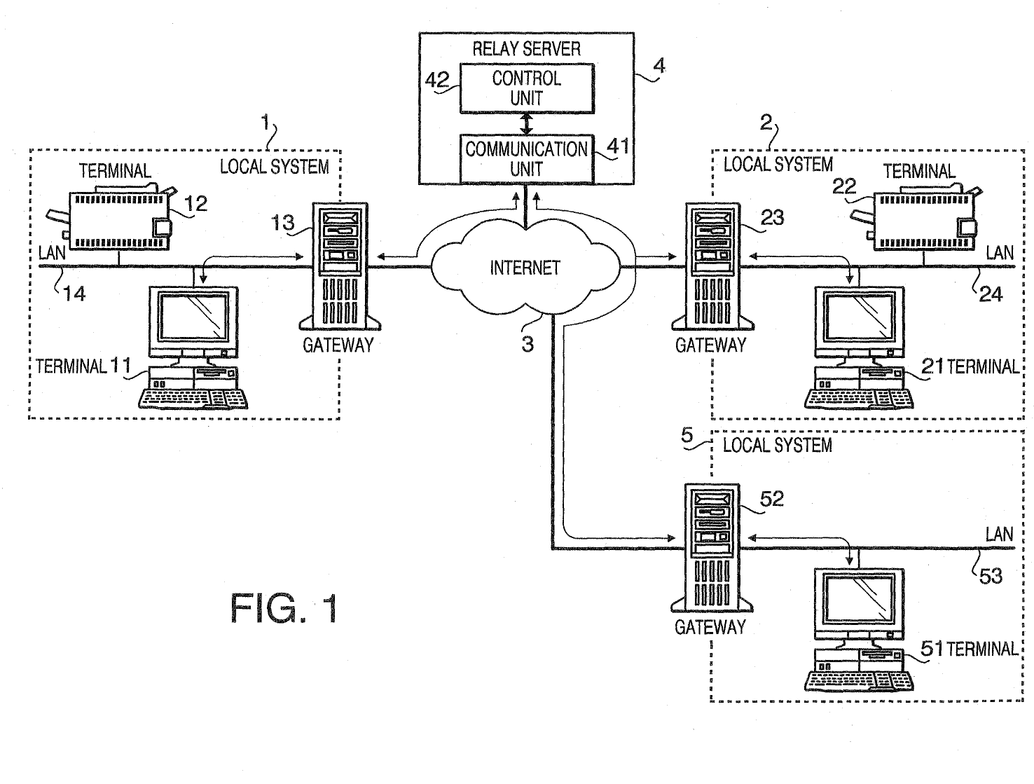

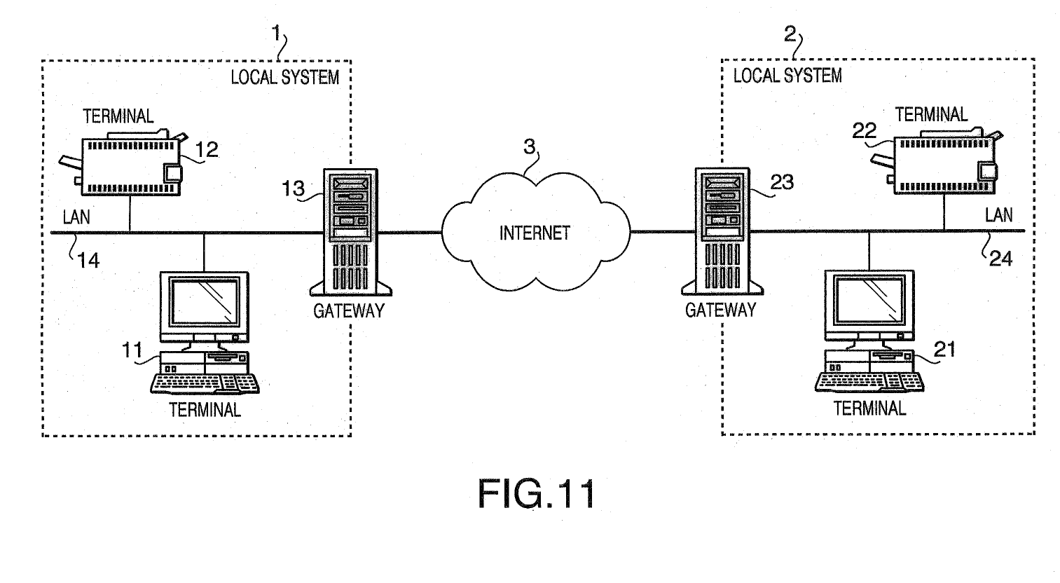

An example of a communication system including a first embodiment of a relay server of the present invention will be described with reference to the drawings. In FIG. 1, the same reference numerals are attached to the same parts as those of FIG. 11, and overlapping description will be abbreviated. The reference numeral 4 designates a relay server, 41 a communication unit, 42 a control unit, 5 a local system, 51 a terminal, 52 a gateway, and 53 a LAN. The local system 5 is a system similar to the local system 1 and the local system 2, and is formed by the terminal 51, the gateway 52 and the like being connected by the LAN 53. The gateway 52 is connected to the Internet 3 along with the LAN 53, and the Internet can be used from various network apparatus such as the terminal 51 on the LAN 53.

The relay server 4 is connected to the Internet 3, and is provided with a global IP address. The relay server 4 is capable of carrying out the communication with various network apparatus via the Internet 3 by using the global IP address. The relay server 4 can be provided with the communication unit 41, and the control unit 42 and/or the like. The communication unit 41 is capable of carrying out the communication with a plurality of network apparatus via the Internet 3.

The control unit 42 receives a login demand transmitted from the network apparatus via the communication unit 41, and reserves a communication path by maintaining the connection with the network apparatus. Moreover, after the relay server 4 receives a login demand, and the communication path is reserved as in the manner stated above, the communication path is maintained until the logout. In addition, a plurality of connections can be provided between the relay server and one network apparatus. When receiving connection demand information from the network apparatus that is connected capable of carrying out the communication, following the connection demand information, the relay server 4 relays the data forwarding between the network apparatus of one side that demanded the connection and the network apparatus of the other side to which the connection is demanded and which is connected to the relay server 4 in the manner the communication can be carried out. Accordingly, the communication is realized between the network apparatus of one side and the network apparatus of the other side. At this time, the data forwarding can be relayed to a plurality of network apparatus at the other side, and accordingly, the broadcasting can be realized.

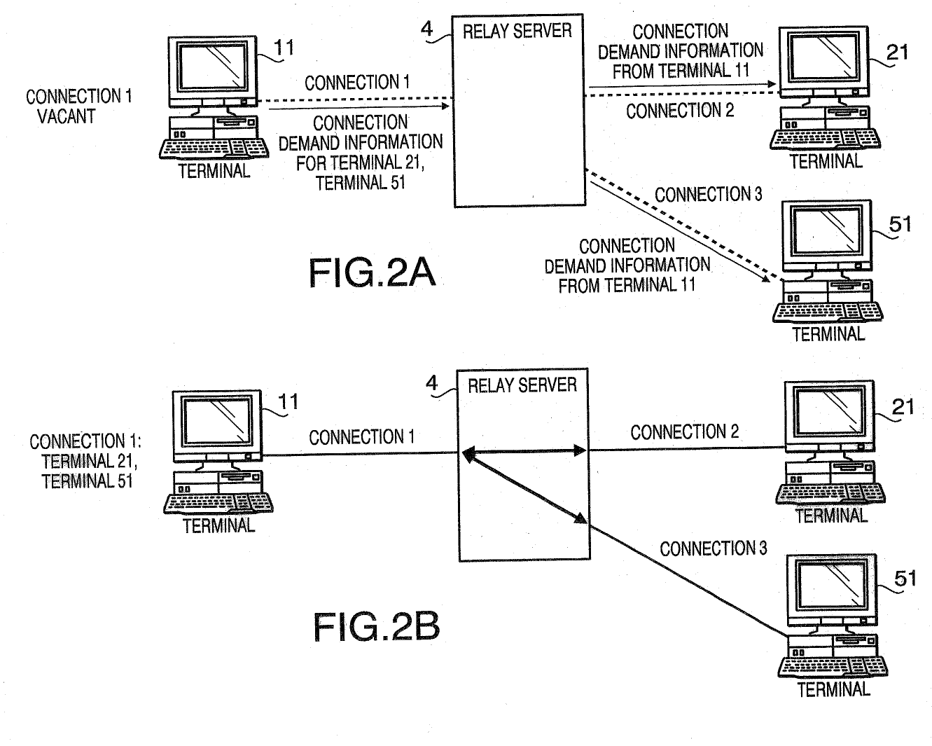

An example of a procedure of broadcasting according to an example of the communication system including the first embodiment of the relay server of the present invention will be described with reference to FIGS. 2A and 2B. Further, in FIGS. 2A and 2B, the gateways and the like are omitted, and an only TCP/IP (Transmission Control Protocol/Internet Protocol) connection between each terminal and the relay server 4 is shown. Further, as for the lines showing respective connections, a broken line shows a state in which the connection is not being used in the communication with other network apparatus by a protocol of application layer (application level), and a solid line shows a state in which the connection is being used in the communication with the other network apparatus by the protocol of the application layer. The same kinds of lines are applied to other drawings.

In FIG. 2A, the terminal 11 is connected to the relay server 4 by a connection 1 in the manner the communication can be carried out. Moreover, as in the same manner, the terminal 21 is connected to the relay server 4 by a connection 2 in the manner the communication can be carried out, and the terminal 51 is connected to the relay server 4 by a connection 3 in the manner the communication can be carried out. Further, at this time, it is assumed that each connection is not being used for the communication with other network apparatus.

Such reservation or reserving of the connection with the relay server 4 can be carried out by demanding login to the relay server 4 via the Internet 3. The connection with the relay server 4 is established at the time of the login, and then, by using the established connection, the communication with the relay server 4 can be carried out. The terminal 11 is a network apparatus within the local system 1, the terminal 21 is a network apparatus within the local system 2, and the terminal 51 is a network apparatus within the local system 5. The connection can be made from the relay server 4 to the gateway 13, the gateway 23, and the gateway 52, but the connection cannot be made directly to the terminal 11, the terminal 21, and the terminal 51. Moreover, as in the manner stated above, the direct communication cannot be carried out among the terminal 11, the terminal 21, and the terminal 51. However, by using the global IP address of the relay server 4, the connection can be made from the terminal 11 to the relay server 4 via the gateway 13, from the terminal 21 to the relay server 4 via the gateway 23, and from the terminal 51 to the relay server 4 via the gateway 52. Therefore, by carrying out the login demand from the terminal 11, the terminal 21, and the terminal 51 to the relay server 4, the communication can be carried out in both directions between the relay server 4 and each of the terminal 11, the terminal 21, the terminal 51 which carried out the login demand.

Moreover, at the time of the login, the information which is to be necessary at the time of the login, for example, the user ID or/and the password are transmitted to the relay server 4 from the network apparatus. The relay server 4 carries out authentication based on the received user ID and the password or the like. As a result of the authentication, the connection with an unspecified third party can be avoided, and the safety can be reserved. In the case of failing in the authentication in that the connection information is not registered or in that the password is incorrect, the relay server 4 carries out a negative response to the terminal 11 or disconnects the connection 1. In the case of succeeding in the authentication, the relay server 4 carried out a positive response to the network apparatus that made the login, and then, until the connection is disconnected, the relay server 4 controls the connection to be maintained. The connection can be maintained by transmitting a connection holding command to the relay server 4 periodically, and obtaining the response of confirmation from the relay server 4.

Under the state in which for example, the terminal 11, the terminal 21, and the terminal 51 are connected to the relay server 4 respectively by such login demands in the manner the communication can be carried out with the relay server, and the communication path is reserved, as an example, the terminal 11 transmits, to the relay server 4, the connection demand information for the terminal 21 and the terminal 51 to the effect that the terminal 11 intends to make connections with the terminal 21 and the terminal 51. When the relay server 4 receives the connection demand information from the terminal 11, the relay server 4 recognizes that the connection destinations indicated in the connection demand information are the terminal 21 and the terminal 51, and forwards the connection demand information from the terminal 11 through the connection 2 reserved between the relay server 4 and the terminal 21, and through the connection 3 reserved between the relay server 4 and the terminal 51. In the case the response returned from the terminal 21 is the positive response, the relay server 4 stores that the connection 2 reserved between the relay server 4 and the terminal 21 is to be used for the communication with the terminal 11. In the case the response returned from the terminal 51 is the positive response, the relay server 4 stores that the connection 3 reserved between the relay server 4 and the terminal 51 is to be used for the communication with the terminal 11. Then, the relay server 4 returns the response returned from each of the terminal 21 and the terminal 51 to the terminal 11.

In the case the terminal 21 and the terminal 51 carried out the positive response to the connection demand from the terminal 11, as shown in FIG. 2B, the communication can be carried out from the terminal 11 to the terminal 21 and the terminal 51. In other words, the relay server 4 receives the information transmitted from the terminal 11 through the connection 1, and forwards the received information to the terminal 21 through the connection 2, and to the terminal 51 through the connection 3. Accordingly, the information transmitted from the terminal 11 through one connection arrives at a plurality of terminals (the terminal 21 and the terminal 51), and the broadcasting is realized substantially. Moreover, in the case the positive response is returned from an only part of the network apparatus, the broadcasting is to be carried out for the only network apparatus that carried out the positive response.

On the other hand, since the communication in both directions can be carried out by each connection, the relay server 4 can receive the data transmitted from the terminal 21, and transmit the received data to the terminal 11, or the relay server 4 can receive the data transmitted from the terminal 51, and transmit the received data to the terminal 11. As in the manner stated above, by using one connection between the terminal 11 and the relay server 4, the communication can be realized with a plurality of network apparatus such as the terminal 21 and the terminal 51.

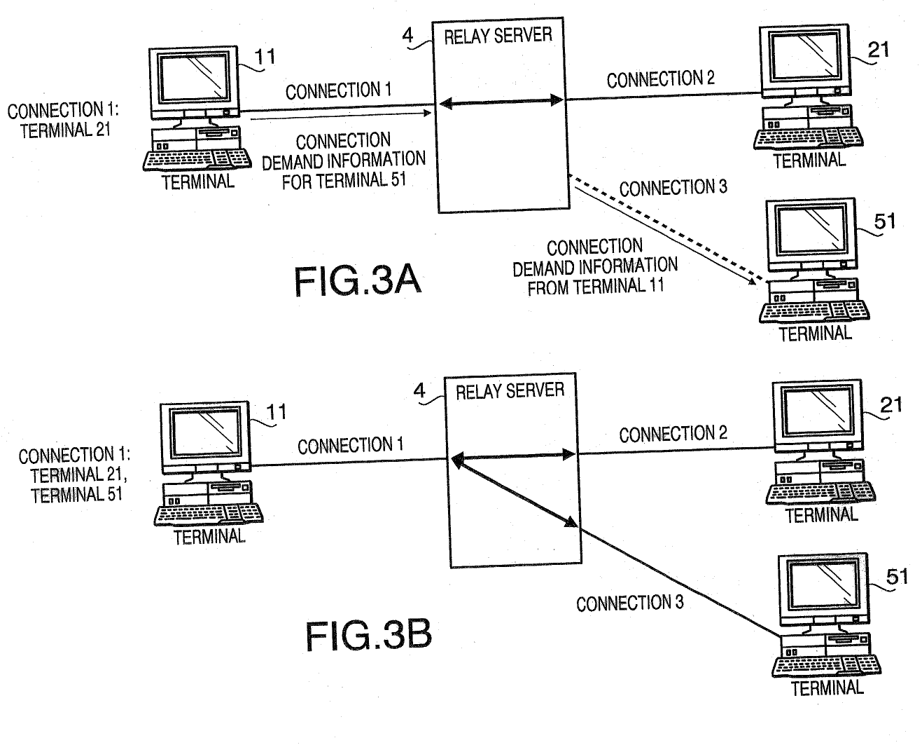

Another example of the procedure of the broadcasting according to the example of the communication system including the first embodiment of the relay server of the present invention will be described with reference to FIGS. 3A and 3B. In the example shown in FIGS. 2A and 2B, it is shown of a case in which the connection demand is carried out to a plurality of network apparatus from the state in which the communication is not being carried between the network apparatus. Moreover, it is possible to add the connection destination afterwards under the state in which the communication is being carried out. In the example shown in FIGS. 3A and 3B, it is shown of a case in which the terminal 51 is added as a new communication destination under the state in which the communication is being carried out between the terminal 11 and the terminal 21.

In FIG. 3A, the terminal 11 is carrying out the communication with the relay server 4 through the connection 1, the terminal 21 is carrying out the communication with the relay server 4 through the connection 2, and the relay server 4 is relaying the communication for both of the terminals 11 and 21. As a result, the communication is realized between the terminal 11 and the terminal 21. Under this state, suppose the information to be transmitted to the terminal 21 is also to be transmitted to the terminal 51 from the terminal 11. In such a case, the terminal 11 transmits connection demand information for the terminal 51 to the relay server 4 through the connection 1 which is being used for the communication. The relay server 4 receives the connection demand information from the terminal 11, recognizes that the connection destination indicated by the connection demand information is the terminal 51, and forwards the connection demand information from the terminal 11 to the terminal 51 through the connection 3.

In the case the positive response is returned from the terminal 51, the relay server 4 stores additionally that the connection 1 through which the connection demand information was received is to be used for carrying out the communication by using the connection 3 through which the positive response was received. The connection 1 is being used for the relaying with the connection 2 originally, and by adding the communication with the connection 3, as shown in FIG. 3B, the information is to be relayed between the connection 1 and the connection 2, and between the connection 1 and the connection 3. In this manner, it is possible to add a communication destination.

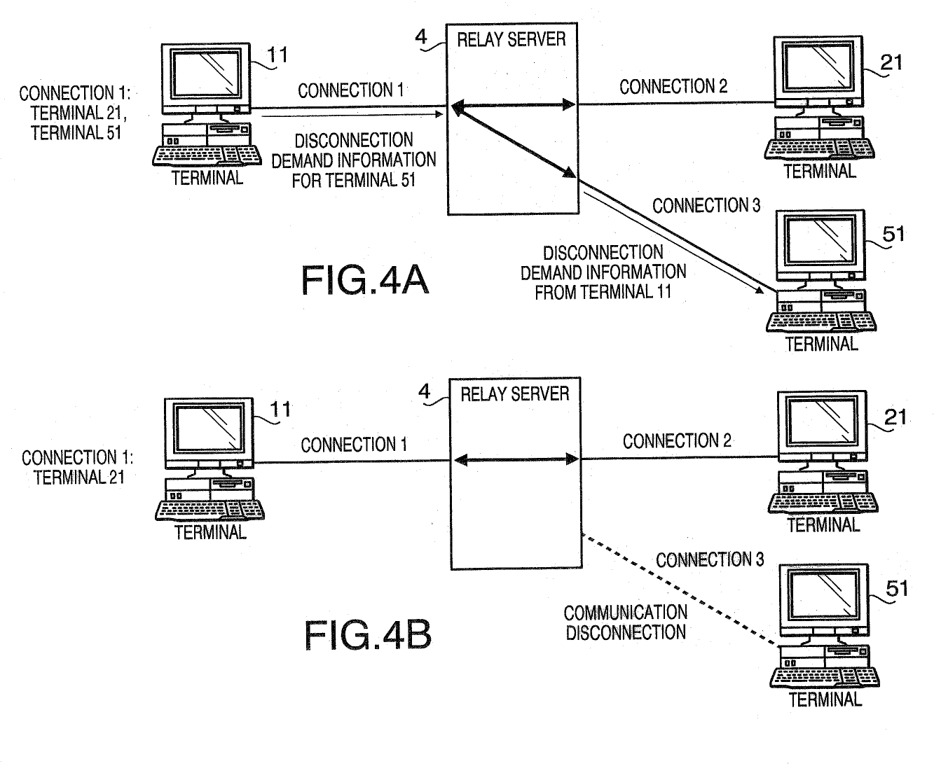

An example of the procedure at the time of disconnection of the broadcasting destination according to the example of the communication system including the first embodiment of the relay server of the present invention will be described with reference to FIGS. 4A and 4B. When the broadcasting is being carried out from the network apparatus of one side to a plurality of network apparatus of the other side as in the manner stated above, it is possible to disconnect the communication for a part of the destinations of the broadcasting. The disconnection of the communication can be indicated from the network apparatus of one side, or can be indicated from the network apparatus of the other side. In the example shown in FIGS. 4A and 4B, it is shown of a case in which the disconnection of the communication with the network apparatus of the other side is carried out from the network apparatus of the one side.

In the example shown in FIG. 4A, it is assumed that by the relaying of the communication by the relay server 4, the communication is carried out between the terminal 11 and the terminal 21, and between the terminal 11 and the terminal 51. Under such a state, when disconnecting the communication with the terminal 51, the terminal 11 transmits, to the relay server 4, via the connection 1, disconnection demand information indicating the disconnection of the communication with the terminal 51. The relay server 4 receives the disconnection demand information from the terminal 11, recognizes that the network apparatus with which the communication is to be disconnected is the terminal 51, and transmits the disconnection demand information from the terminal 11 to the terminal 51 through the connection 3. At the same time, the association between the connection 1 and the connection 3 is dissolved, and the relaying of the communication between both sides is ended.

Accordingly, as shown in FIG. 4B, the information transmitted from the terminally is transmitted only to the terminal 21, and is not transmitted to the terminal 51. Further, the connection 3 between the terminal 51 and the relay server 4 can be maintained, or the connection 3 itself can be disconnected. Moreover, by designating a plurality of network apparatus in the disconnection demand information, the communication with a plurality of network apparatus can be disconnected at the same time. Furthermore, in the case of ending the communication with all terminals, the disconnection demand information designating all connected network apparatus can be transmitted to the relay server 4. Moreover, in the case the network apparatus is not designated, it may be regarded that the communication with all network apparatus should be disconnected, and the communication with all network apparatus may be disconnected.

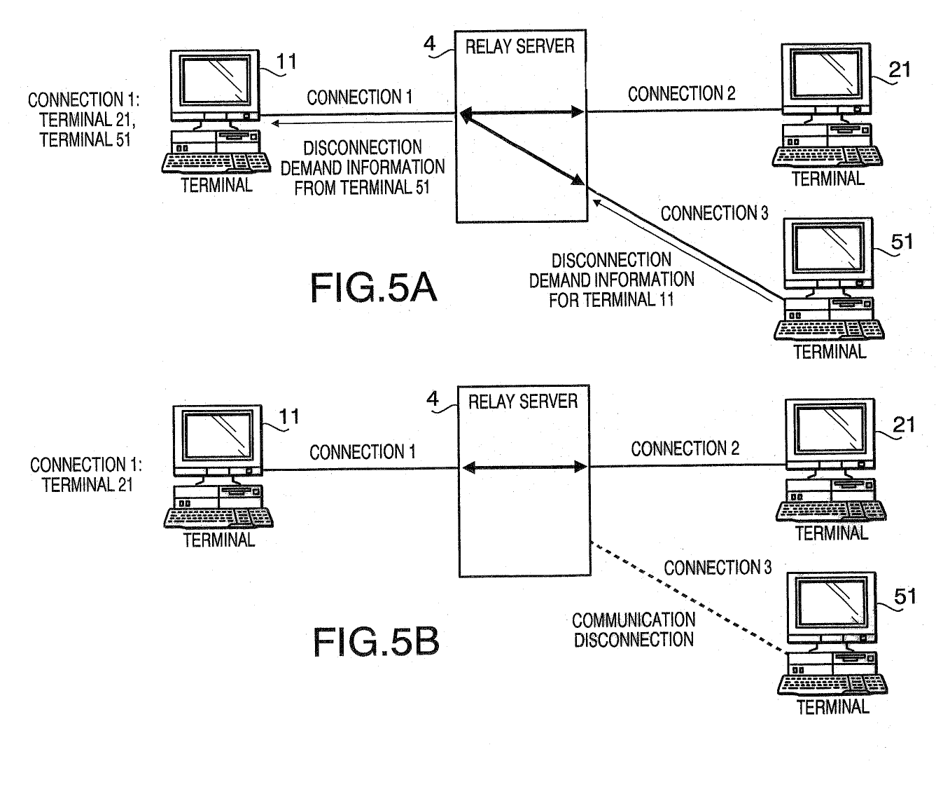

Another example of the procedure when disconnecting the destination of the broadcasting according to the example of the communication system including the first embodiment of the relay server of the present invention will be described with reference to FIGS. 5A and 5B. In the example shown in FIGS. 5A and 5B, it is shown of an example in which the communication is disconnected for a part of the destinations of the broadcasting as in the same manner of FIGS. 4A and 4B, but this example differs from FIGS. 4A and 4B in that it is shown of a case in which by indicating from the network apparatus of the other side, the communication with the network apparatus of one side is disconnected.

In the example shown in FIG. 5A, it is assumed that by the relaying of the communication by the relay server 4, the communication is being carried out between the terminal 11 and the terminal 21, and between the terminal 11 and the terminal 51. Under such a state, in the case the terminal 51 disconnects the communication with the terminal 11, the terminal 51 transmits, to the relay server 4, via the connection 3, the disconnection demand information for disconnecting the communication with the terminal 11. The relay server 4 receives the disconnection demand information from the terminal 51, recognizes that the network apparatus with which the communication is disconnected is the terminal 11, and transmits the disconnection demand information from the terminal 51 to the terminal 11 through the connection 1. At the same time, the association between the connection 1 and the connection 3 is dissolved, and the relaying of the communication between both sides is ended. At this time, the association between the connection 1 and the connection 2 remains as it is. As a result, the communication with the terminal 11 and the terminal 21 can be continued.

As in the manner stated above, as shown in FIG. 5B, the information transmitted from the terminal 11 is transmitted only to the terminal 21, and is not transmitted to the terminal 51. Further, in this case, the connection 3 between the terminal 51 and the relay server 4 can be maintained, or the connection 3 itself can be disconnected.

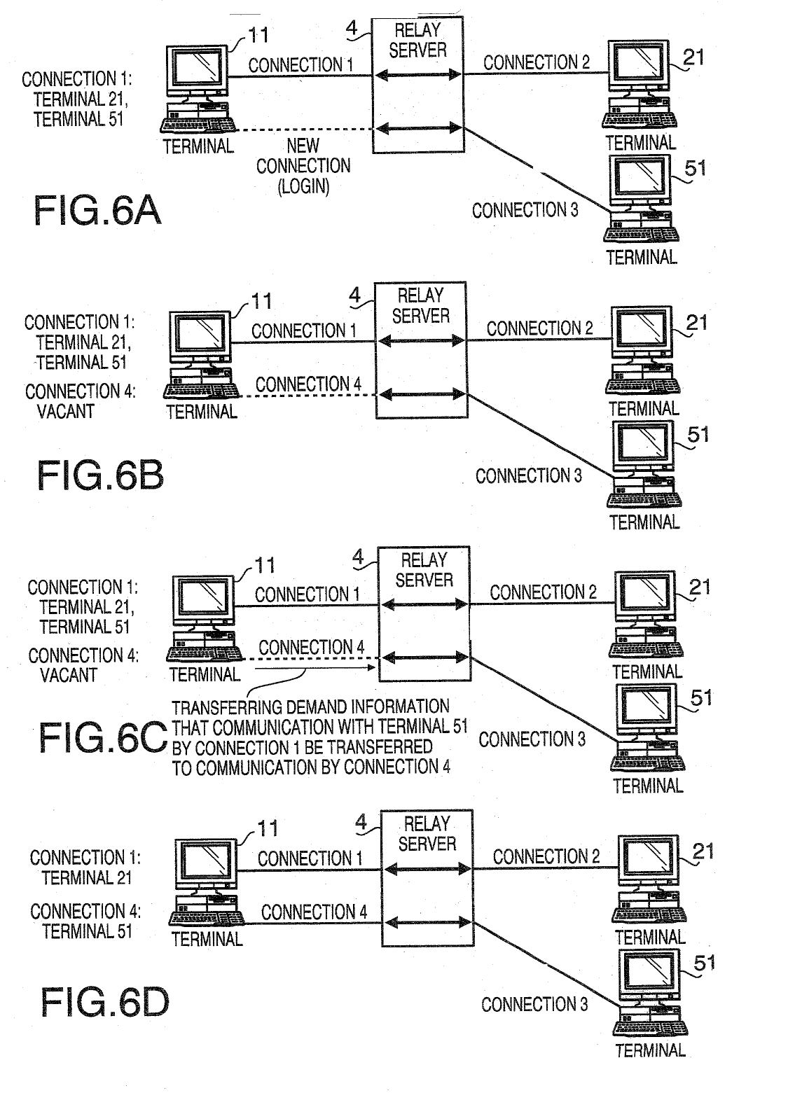

An example of the procedure when transferring the communication with the destination of the broadcasting to the communication using a different connection according to the example of the communication system including the first embodiment of the relay server of the present invention will be described with reference to FIGS. 6A to 6D. When the broadcasting is carried out, the communication is to be carried out between one network apparatus of one side and plural network apparatus of the other side. The communication with a part of these plural network apparatus of the other side can be transferred to communication using a different connection. Therefore, it is possible to transmit, to a part of the plural network apparatus, information different from information transmitted to the other network apparatus of the plural network apparatus, and it is possible to receive, from a part of the plural network apparatus, information different from information received from the other network apparatus of the plural network apparatus. FIGS. 6A to 6D show the procedure when carrying out such a change of the connection.

In the example shown in FIG. 6A, by the relaying of the communication by the relay server 4, the communication is being carried out between the terminal 11 and the terminal 21, and between the terminal 11 and the terminal 51. Under such a state, the information transmitted from the terminal 11 is forwarded not only to the terminal 2 but also to the terminal 51. At this time, suppose the terminal intends to carry out communication with the terminal 51 different from communication with the terminal 21. In such a case, first, the terminal 11 carries out the login demand newly to the relay server 4 so as to provide a new connection 4 as shown in FIG. 6B. In the case the terminal 11 has been already provided with the connection which is not used in the communication with other network apparatus, it is not necessary to reserve a connection by such a new login demand. Further, even when the new connection 4 is provided, the communication with the terminal 21 and the terminal 51 is continued through the connection 1 at this time.

Subsequently, as shown in FIG. 6C, by using the connection 4, the terminal 11 transmits transferring demand information to the relay server 4 which indicates the communication with the terminal 51 being carried out using the connection 1 is to be transferred to the communication using the connection 4. The relay server 4 receives the transferring demand information from the terminal 11, and by following the contents of the demand, the relay server 4 dissolves the association between the connection 1 and the connection 3, disconnects the communication using the connection 1 and the connection 3, and associates the connection 4 with the connection 3. Then, as shown in FIG. 6D, the relay server 4 starts the communication between the terminal 11 and the terminal 51 by using the connection 4 and the connection 3.

As in the manner stated above, it is possible to change a connection such that communication with a part of the network apparatus to which the broadcasting is being carried out is transferred to the different communication which uses a different connection. Of course, by performing both the disconnection demand and the connection demand, the change of the connection can be realized likewise. As in the same manner, a network apparatus of the other side may transmit transferring demand information to the relay server, and based on the transferring demand information, the communication between the network apparatus of the one side and the network apparatus of the other side which has transmitted the transferring information may be transferred to communication using a different connection.

Meanwhile, it is possible to unite, into one connection, different connections through which different communication with a plurality of network apparatus is being carried out respectively so as to perform broadcasting together for a plurality of network apparatus by using this united one connection. As described above, for, example, it is possible to actively divide communication into two or more individual communication, and/or unite two or more individual communication destinations as broadcasting destinations.

Further, hereinabove, it was described of a case in which the communication is carried out between the network apparatus that are all connected to the relay server 4. However, the present invention is not to be limited to such a case. For example, a plurality of relay servers can be provided on the Internet 3, and by carrying out the relay communication between the relay servers, also as for the network apparatus that are connected to different relay servers, the broadcasting can be carried out likewise. Furthermore, the change of the connection or the like can be carried out in the same manner. Moreover, the relay server for relaying the communication between the relay servers may be provided, and the communication path between the different relay servers to which the network apparatus are connected may be selected arbitrarily. In addition, the number of relay servers provided on the Internet 3 may be also arbitrary.

(Second Embodiment)

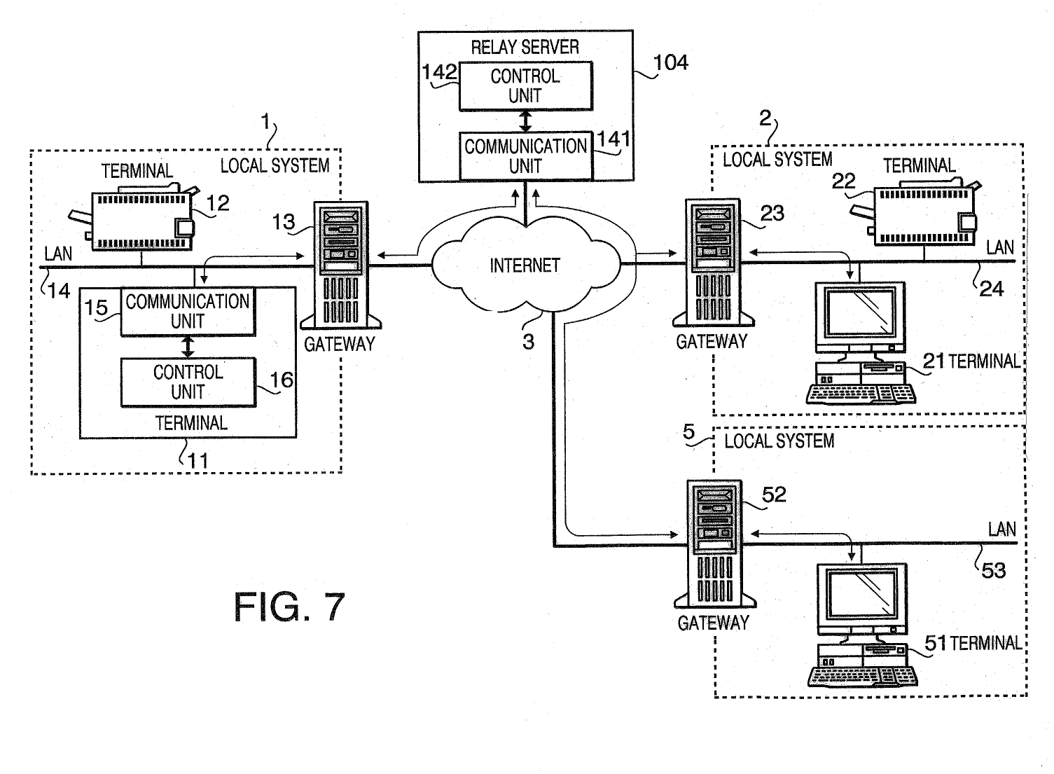

A second embodiment of a communication system of the present invention will be described with reference to the drawings. In FIG. 7, the same reference numerals are attached to the same parts as those of FIGS. 1 and 11, and overlapping description will be abbreviated. The reference numeral 15 designates a communication unit, 16 a control unit, 104 a relay server, 141 a communication unit, and 142 a control unit.

The relay server 104 is connected to the Internet 3, and is provided with a global IP address. By using the global IP address, the relay server 104 is capable of carrying out the communication with various network apparatus via the Internet 3. The relay server 104 can be provided with the communication unit 141, the control unit 142 or/and the like. The communication unit 141 establishes a connection in accordance with the login demand from the network apparatus, and carries out the communication with the network apparatus through the connection. Further, the relay server can make connections with a plurality of network apparatus, and can establish a plurality of connections with one network apparatus.

The control unit 142 receives the login demand transmitted from the network apparatus via the communication unit 141, maintains the connection with the network apparatus through the communication unit 141, and reserves the communication path until the logout. Moreover, when the control unit 142 receives the connection demand information from the network apparatus that is connected capable of carrying out the communication, following the connection demand information, the relay server 104 associates connections with each other which are respectively a connection with the network apparatus which demanded the connection and a connection with the network apparatus to which the connection is demanded and connected to the relay server such that the network apparatus can carry out communication with the relay server 104. Then, the control unit 142 relays the data forwarding between the network apparatus. In other words, when receiving the information transmitted from the network apparatus of one side, the control unit 142 finds a connection with the network apparatus of the other side which is associated with the connection through which this information was transmitted from the network apparatus of the one side, and the relay server 104 forwards the received information through this found connection. The communication in the opposite direction can be carried out in the same manner. Accordingly, the communication can be realized between the network apparatus of the one side and the network apparatus of the other side.

The terminal 11 of the local system 1 carries out the login demand to the relay server 104 on the Internet 3 via the gateway 13 as in the manner stated above, the connection is established, and the communication can be carried out in both directions between the terminal 11 and the relay server 104. The terminal 11 is provided with at least the communication unit 15 and the control unit 16 in order to perform these processes. The communication unit 15 carries out the communication with the relay server 104 on the Internet 3 via the gateway 13 substantially, by the communication using the LAN 14. At this time, the terminal 11 can establish a plurality of connections with the relay server 104, and carry out the communication selectively.

The control unit 16 carries out transmission and reception of the information by the communication with the relay server 104 and other network apparatus through the communication unit 15. In the case a plurality of connections are reserved with the relay server 104 by the communication unit 15, the communication can be carried out by using each of the connections selectively. For example, by selecting one connection, the connection demand information can be transmitted from the terminal 11 to the relay server 104 in order to demand the communication with the other network apparatus. When the communication becomes possible to be carried out, the information is forwarded to the other network apparatus of the destination, or the forwarding of the information can be received by the terminal 11. Moreover, in the case each of a plurality of connections can be used for communication with each network apparatus, the same information can be transmitted through all of or a part of these connections so as to perform the broadcasting communication.

Further, the terminal 12 of the local system 1, or the terminals in the local system 2 and the local system 5 may have the same structure as that of the terminal 11. Of course, structure of these terminals may be any structure so long as these terminals can make connections with the relay server 104 to carry out the communication with the relay server.

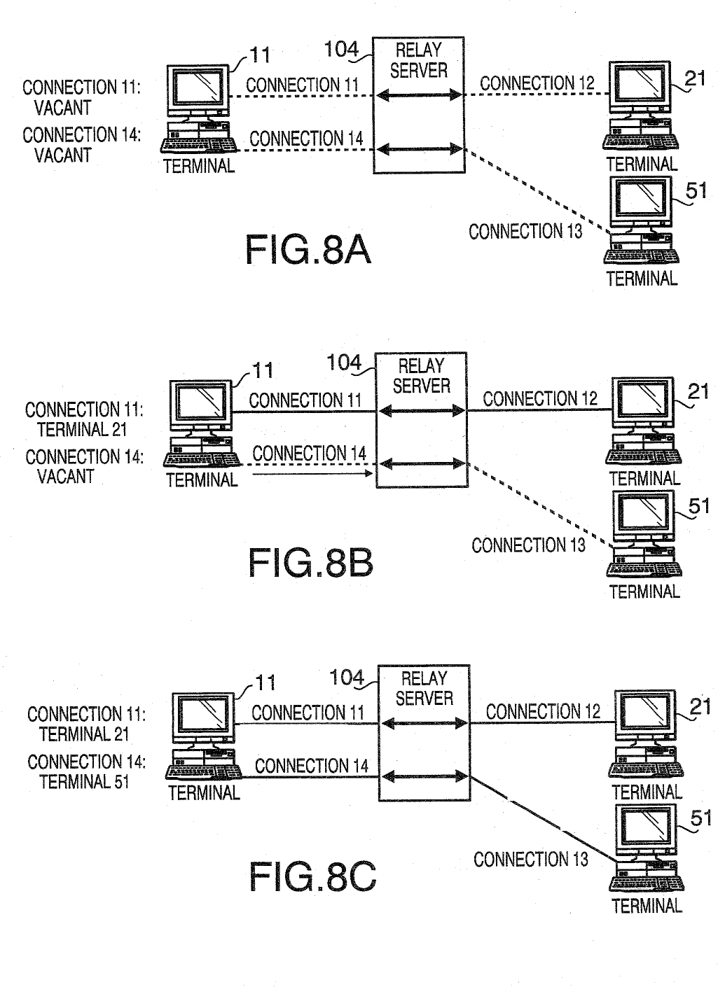

An example of the operation according to the second embodiment of the communication system of the present invention will be described with reference to FIGS. 8A to 8C. Further, in each of FIGS. 8A to 8C, the gateway and the like are omitted, and only the TCP/IP connection between each terminal and the relay server 104 is shown. Further, as for the line showing each connection, the broken line shows the state in which each connection is not being used for the communication with other network apparatus by the protocol of the application level, and the solid line shows the state in which each connection is being used for the communication with other network apparatus by the protocol of the application level.

In FIG. 8A, the terminal 11 is connected to the relay server 104 by the connection 11 in the manner the communication can be carried out. Moreover, as in the same manner, the terminal 21 is connected to the relay server 104 by the connection 12 in the manner the communication can be carried out, and the terminal 51 is connected to the relay server 104 by the connection 13 in the manner the communication can be carried out. Further, at this time, it is assumed that each connection is not being used for the communication with the other network apparatus.

By demanding the login to the relay server 104 via the Internet 3, reserving of such a connection with the relay server 104 can be carried out. The connection with the relay server 104 is established at the time of the login, and then, by using the established connection, the communication with the relay server 104 can be carried out. The terminal 11 is a network apparatus within the local system 1, the terminal 21 is a network apparatus within the local system 2, and the terminal 51 is a network apparatus within the local system 5. The connections can be made from the relay server 104 to the gateway 13, the gateway 23, and the gateway 52, but the connection cannot be made directly from the relay server 104 to the terminal 11, the terminal 21, or the terminal 51. Moreover, as in the manner stated above, the communication cannot be carried out directly between the respective terminals 11, 21, and 51. However, by using the global IP address of the relay server 104, the connections can be made to the relay server 104 from the terminal 11 via the gateway 13, from the terminal 21 via the gateway 23, and from the terminal 51 via the gateway 52. Therefore, by demanding the login to the relay server 104 from the terminal 11, the terminal 21, and the terminal 51, the communication can be carried out in both directions between the relay server 104 and each of the terminal 11, the terminal 21, and the terminal 51 which demanded the login.

Moreover, at the time of the login, the information which is to be necessary at the time of the login, for example, the user ID and the password are transmitted to the relay server 104 from the network apparatus. The relay server 104 carries out the authentication based on the received user ID and the password or the like. As a result of the authentication, the connection with an unspecified third party can be avoided, and the safety can be reserved. In the case of failing in the authentication in that the connection information is not registered or in that the password is incorrect, the relay server 104 carries out the negative response to the network apparatus, or disconnects the connection. In the case of succeeding in the authentication, the relay server 104 carries out the positive response to the network apparatus that logged in, and then, until the connection is disconnected, the relay server 104 performs control so as to continue the connection. The connection can be continued by transmitting the connection holding command to the relay server 104 periodically, and obtaining the response of confirmation from the relay server 104.

As for the above-described connection between the network apparatus and the relay server 104, it is possible to establish not only one connection but also a plurality of connections with each network apparatus. For example, in the example shown in FIG. 8A, after the connection 11 is established, the terminal 11 makes the login to the relay server 104 again, and the connection 14 is established. Moreover, three or more connections may be established.

Under the state in which by following the login demand, for example, the terminal 11, the terminal 21, and the terminal 51 are connected to the relay server 104 respectively in the manner the communication can be carried out with the relay server, and the communication path is reserved, it is assumed that communication between the terminal 11 and the terminal 21 first becomes possible. For example, the terminal 11 transmits the connection demand information for the terminal 21 to the relay server 104 via the connection 11 in order to make it possible to carry out the communication between the terminals 11 and 21. When receiving the connection demand information from the terminal 11 via the connection 11, the relay server 104 recognizes that the destination indicated within the connection demand information is the terminal 21, and forwards the connection demand information from the terminal 11 to the terminal 21 through the connection 12 that is reserved between the relay server 104 and the terminal 21. The terminal 21 determines whether the communication can be carried out, based on the received connection demand information, and returns the response through the connection 12 through which the connection demand information was forwarded. In the case the response returned from the terminal 21 is the positive response, the relay server 104 associates the connection 11 with the connection 12, and stores that these connections 11 and 12 are to be used for communication between the terminal 11 and the terminal 21.

In the case the terminal 21 carried out the positive response to the connection demand from the terminal 11, as shown in FIG. 8B, the communication between the terminal 11 and the terminal 21 becomes possible. In other words, the relay server 104 receives the information transmitted from the terminal 11 through the connection 11, and forwards the received information to the terminal 21 through the connection 12. As a result, the information transmitted from the terminal 11 through the connection 11 arrives at the terminal 21 through the connection 12, and meanwhile, the information transmitted from the terminal 21 through the connection 12 arrives at the terminal 11 through the connection 11. Therefore, the communication can be carried out between the terminal 11 and the terminal 21.

As in the same manner, for the communication to be carried out between the terminal 11 and the terminal 51, for example, the terminal 11 transmits the connection demand information for the terminal 51 to the relay server 104 via the connection 14. When receiving the connection demand information from the terminal 11 via the connection 14, the relay server 104 recognizes that the destination indicated within the connection demand information is the terminal 51, and forwards the connection demand information from the terminal 11 to the terminal 51 through the connection 13 that is reserved between the relay server 104 and the terminal 51. The terminal 51 determines whether the communication can be carried out, based on the received connection demand information, and returns the response through the connection 13 through which the connection demand information was transmitted. In the case the response returned from the terminal 51 is the positive response, the relay server 104 associates the connection 14 with the connection 13, and stores that these connections 13 and 14 are to be used between the terminal 11 and the terminal 51.

In the case the terminal 51 carried out the positive response to the connection demand from the terminal 11, as shown in FIG. 8C, the communication between the terminal 11 and the terminal 51 becomes possible. In other words, the relay server 104 receives the information transmitted from the terminal 11 through the connection 14, and forwards the received information to the terminal 51 through the connection 13. As a result, the information transmitted form the terminal 11 through the connection 14 arrives at the terminal 51 through the connection 13, and meanwhile, the information transmitted from the terminal 51 through the connection 13 arrives at the terminal 11 through the connection 14. Therefore, the communication can be carried out between the terminal 11 and the terminal 51.

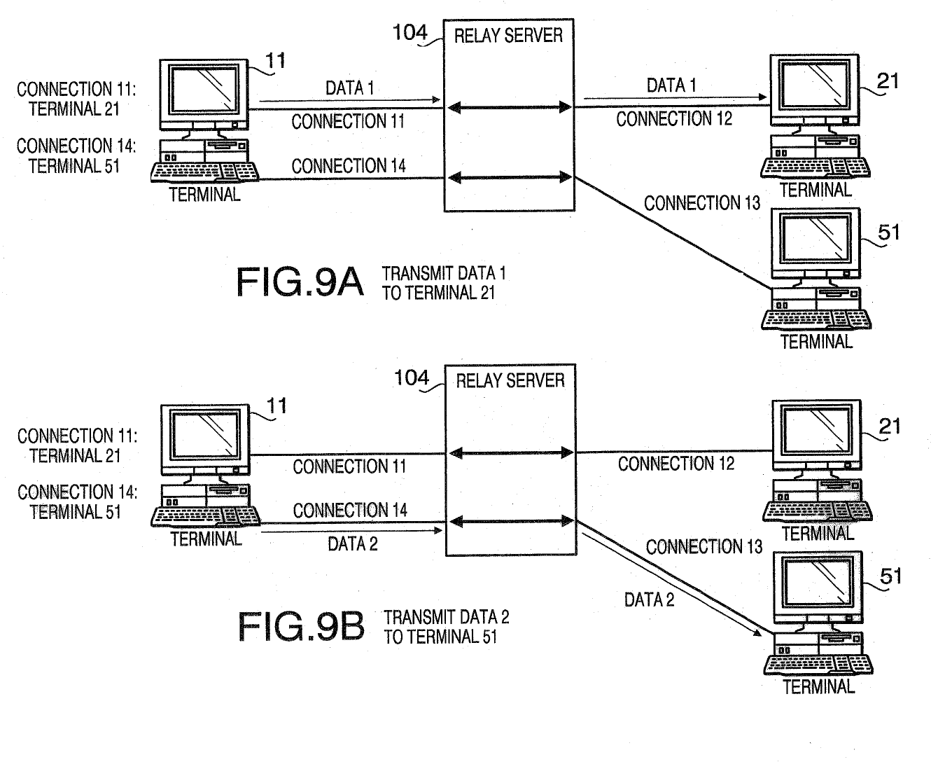

As shown in FIG. 8C, in the case the communication can be carried out between the terminal 11 and the terminal 21, and between the terminal 11 and the terminal 51, the communication can be carried out individually with each of the terminal 21 and the terminal 51. One example of individual communication will be described with reference to FIGS. 9A and 9B. FIG. 9A shows an example in which data 1 is transmitted from the terminal 11 to the terminal 21. The terminal 11 transmits the data 1 via the connection 11. Then, the relay server receives the data 1 through the connection 11, and forwards the received data 1 through the connection 12 associated with the connection 11. Accordingly, the data 1 transmitted from the terminal 11 arrives at the terminal 21. Meanwhile, the data transmitted from the terminal 21 also arrives at the terminal 11 via the connection 12 and the connection 11.

In the case the terminal 11 carries out the communication through the connection 11 as in the manner stated above, the data 1 is not sent to the terminal 51 which also can carry out the communication with the terminal 11. When carrying out the communication with the terminal 51, the terminal 11 uses the connection 14. FIG. 9B shows an example in which the data 2 is transmitted from the terminal 11 to the terminal 51. The terminal 11 transmits the data 2 via the connection 14. Then, the relay server receives the data 2 from the connection 14, and forwards the received data 2 through the connection 13 associated with the connection 14. Accordingly, the data 2 transmitted from the terminal 11 arrives at the terminal 51. Meanwhile, the data transmitted from the terminal 51 also arrives at the terminal 11 via the connection 13 and the connection 14.

As in the manner stated above, the terminal 11 can carry out the communication individually with the terminal 21 through the connection 11, and with the terminal 51 through the connection 14.

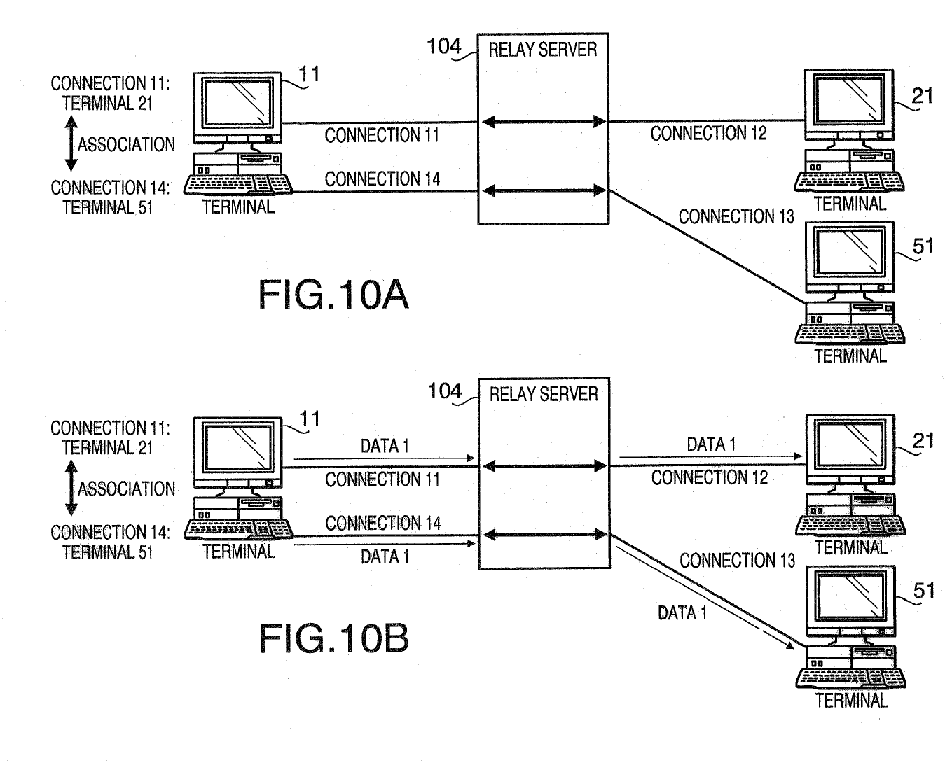

An example of the broadcasting will be described with reference to FIGS. 10A and 10B. When the communication can be carried out between the terminal 11 and the terminal 21, and between the terminal 11 and the terminal 51 as shown in FIG. 8C, the broadcasting can be carried out to the terminal 21 and the terminal 51. When carrying out the broadcasting, as shown in FIG. 10A, first, the terminal 11 associates connections in order to carry out the broadcasting to the destinations. In this example, the terminal 11 associates the connection 12 with the connection 11 to be used for communication with the terminal 21, and associates the connection 13 with the connection 14 to be used for communication with the terminal 51.

Then, the terminal 11 transmits the same data through each of the associated connections. It is assumed that the terminal 11 transmits the data 1 to the terminal 21 and the terminal 51 by the broadcasting, and as shown in FIG. 10B, the terminal 11 transmits the data 1 through the connection 11 and also transmits the data 1 through the connection 14.

The relay server 104 can carry out the relaying as in the same manner as in the abovementioned individual communication. In other words, the relay server 104 receives the data 1 transmitted from the terminal 11 through the connection 11, and forwards the received data 1 to the terminal 21 through the connection 12 associated with the connection 11. Accordingly, the data 1 transmitted from the terminal 11 arrives at the terminal 21. As in the same manner, the relay server 104 receives the data 1 transmitted from the terminal 11 through the connection 14, and forwards the received data 1 to the terminal 51 through the connection 13 associated with the connection 14. Accordingly, the data 1 transmitted from the terminal 11 arrives at the terminal 51.

As in the manner stated above, the data 1 transmitted from the terminal 11 arrives at the terminal 21 and the terminal 51, and the broadcasting can be realized. At this time, it is sufficient that the relay server 104 only performs the relaying of the one-to-one communication, and even if the relay server 104 is not provided with the function for broadcasting, by using the only function of the side of the terminal, it is possible to carry out the broadcasting.

In the above description, the data was forwarded from the terminal 11 to the terminal 21 and the terminal 51. Meanwhile, the data transmitted from the terminal 21 arrives at the terminal 11 via the connection 12 and the connection 11, and the data transmitted from the terminal 51 arrives at the terminal 11 via the connection 13 and the connection 14. In this example, the broadcasting cannot be carried out to other terminals from the terminal 21 or the terminal 51. However, by providing different connections between the terminal 21 and the terminal 51 which can be used for the communication, the broadcasting can be carried out reciprocally.

Moreover, the terminal 11 is capable of performing the communication with the respective terminals 21 and 51 and the like by carrying out switching between the individual communication and the broadcasting selectively. For example, in the case while the broadcasting is being carried out, there is the information which is desirable to be transmitted only to the terminal 21, such information can be transmitted only through the connection 11. Moreover, for example, in the case while the individual communication is being carried out, necessity is generated that the broadcasting should be carried out, the same data may be forwarded by using other connections at this time.

Further, in the above description, all communication is carried out between the network apparatus that are connected to the relay server 104. However, the present invention is not to be limited to such a case. For example, it can be applied for the case in which a plurality of relay servers are provided on the Internet 3, and the network apparatus are connected to different relay servers. For example, by carrying out the communication between the relay servers that are connected with the network apparatus, the communication can be carried out between the network apparatus that are connected to different relay servers, and the above-mentioned broadcasting can be realized in the same manner. Moreover, the same manner applies to the case in which only part of the destinations of the broadcasting are connected to the other relay servers, or the case in which each of the destinations of the broadcasting is connected to a different relay server respectively. In addition, the relay server for relaying the communication between the relay servers can be provided, and the communication path between separate relay servers connected with the network apparatus is also arbitrary. Moreover, the number of the relay servers provided on the Internet 3 is also arbitrary.

What is claimed is:

1. A relay server comprising:
communication means capable of carrying out communication with a plurality of network apparatus; and
control means for carrying out broadcasting transmission by relaying communication between a network apparatus of one side and a plurality of network apparatus of the other side,
wherein the network apparatus of the one side and the plurality of network apparatus of the other side are connected to the relay server so as to enable communication with the relay server.

2. The relay server according to claim 1, wherein the relay server receives connection demand information through a connection from the network apparatus of the one side, recognizes connection destinations indicated in the connection demand information, and forwards the connection demand information through connections to the plurality of network apparatus of the other side which correspond to the connection destinations, and if the relay server receives positive responses to the connection demand information returned from the connection destinations, the relay server forwards information transmitted from the network apparatus of the one side to the connection destinations which has returned the positive responses.

3. The relay server according to claim 2, wherein the connection and the connections are respectively established at the time the network apparatus of the one side and the plurality of network apparatus of the other side respectively make login to the relay server.

4. The relay server according to claim 3, wherein at the time the network apparatus of the one side and the plurality of network apparatus of the other side respectively make login to the relay server, the relay server receives user IDs and passwords which are respectively transmitted from the network apparatus of the one side and the plurality of network apparatus of the other side, and makes authentication of the network apparatus of the one side and the plurality of network apparatus of the other side by using the user IDs and the passwords.

5. The relay server according to claim 1, wherein based on a releasing demand transmitted from the network apparatus of the one side, the control means disconnects the communication between the network apparatus of the one side and one or more network apparatus of the plurality network apparatus of the other side which have been designated by the releasing demand.

6. The relay server according to claim 1, wherein based on a releasing demand transmitted from one or more network apparatus of the plurality of network apparatus of the other side, the control means disconnects the communication between the network apparatus of the one side and said one or more network apparatus of the plurality network apparatus of the other side which have transmitted the releasing demand.

7. The relay server according to claim 1, 5, or 6, wherein based on a demand transmitted from the network apparatus of the one side, the control means can transfer the communication between the network apparatus of the one side and a network apparatus of the plurality of network apparatus of the other side which has been designated by the demand, to communication using a connection which is used between the network apparatus of the one side and the relay sever and is different from a connection which has been being used between the network apparatus of the one side and the relay server.

8. The relay server according to claim 1 or 5, wherein based on a demand transmitted from a network apparatus of the plurality of network apparatus of the other side, the control means can transfer the communication between the network apparatus of the one side and the network apparatus of the plurality of network apparatus of the other side which has transmitted the demand, to communication using a connection which is used between the network apparatus of the one side and the relay sever and is different from a connection which has been being used between the network apparatus of the one side and the relay server.

9. The relay server according to claim 1, wherein the relay server receives data through a connection from the network apparatus of the one side, and forwards the received data through a plurality of connections to the plurality of network apparatus of the other side such that the data forwarded through the plurality of connections is same as each other.

10. The relay server according to claim 1, wherein the relay server receives same data through a plurality of connections from the network apparatus of the one side, and forwards, to the plurality of network apparatus of the other side, the same data through connections which are respectively associated with the plurality of connections.

11. The relay server according to claim 1, wherein control means relays the communication between the network apparatus of the one side and the plurality of network apparatus of the other side which are located within local systems different from a first local system within which the network apparatus of the one side is located, and the relay server exists on the Internet.

12. The relay server according to claim 11, wherein the relay server carries out, via a gateway, the communication with the network apparatus of the one side within the first local system, and carries out, via gateways, the communication with the plurality of network apparatus of the other side within the local systems which are different from the first local system.

13. A communication system comprising:
a plurality of network apparatus; and
a relay server for relaying communication for a plurality of network apparatus by using connections with the plurality of network apparatus,
wherein one network apparatus of the plurality of network apparatus transmits same data to the relay server through a plurality of connections between the one network apparatus and the relay server so as to realize broadcasting communication.

14. The communication system according to claim 13, wherein each of the plurality of connections is associated with each connection which is provided between the relay server and each of other network apparatus of the plurality of network apparatus.

15. A communication method comprising:
receiving data from a network apparatus through a part of or all of a plurality of connections after the plurality of connections with the network apparatus are reserved; and
forwarding the received data to another or other network apparatus,
wherein when broadcasting communication is carried out, the received data is forwarded to the other network apparatus.

16. The communication method according to claim 15, wherein when the broadcasting is carried out, the data is received through the plurality of connections from the network apparatus, the data received through the plurality of connections is same as each other, and the received data is forwarded to the other network apparatus through connections which are respectively associated with the plurality of connections.

17. A network apparatus comprising:
communication means for establishing a plurality of connections with a relay server via a network so as to carry out communication with the relay server; and
control means for enabling communication with another or other network apparatus by using a part of or all of the established plurality of connections with the relay server, and causing the communication means to transmit same data through the plurality of connections so as to carry out broadcasting communication,
wherein the network apparatus is used in a communication system for realizing communication among the network apparatus and the another network apparatus or the other network apparatus which are connected to the relay server, and in the communication system, the relay server relays the communication.
